(19) United States
(12) Patent Application Publication
(10) Pub. No.: US 2006/0236833 A1
(43) Pub. Date: Oct. 26, 2006

(54) Fence arrangement for a miter saw

(76) Inventors: Daryl S. Meredith, York, PA (US); Craig A. Oktavec, Forest Hill, MD (US); Thomas R. Kaye JR., Bel Air, MD (US); Brian P. Wattenbach, Menomonee Falls, WI (US); Frederick R. Bean, Finksburg, MD (US)

Correspondence Address: THE BLACK & DECKER CORPORATION, 701 EAST JOPPA ROAD, TW199, TOWSON, MD, 21286, US

(21) Appl. No.: 11/397,462

(22) Filed: Apr. 4, 2006

Related U.S. Application Data
(60) Provisional application No. 60/674,634, filed on Apr. 25, 2005.

(51) Int. Cl. B23D 45/04

(52) U.S. Cl. 83/471.3; 83/490

(57) ABSTRACT

A saw having a base having a first substantially horizontal surface for supporting a workpiece and a second substantially horizontal surface disposed below the first surface. The saw also has a table rotatably attached to the base, the table being substantially coplanar with the first surface, and a saw assembly pivotally attached to the table. The saw assembly includes a motor and a blade driven by the motor. The saw has a fixed fence disposed on the second surface and fixedly attached to the base.

### CROSS-REFERENCE TO RELATED APPLICATIONS

This application derives priority from U.S. application No. 60/674,634, filed Apr. 25, 2005.

### FIELD OF THE INVENTION

This invention relates generally to miter saws and specifically to fence arrangements for miter saws.

### BACKGROUND OF THE INVENTION

It is well known to provide fences on miter saws for supporting a workpiece disposed thereagainst. The fences may include a fixed portion and a slidable portion slidably disposed on the fixed portion, as disclosed in U.S. Pat. Nos. 5,297,463 and 5,943,931.

It is desirable to improve such fences.

### SUMMARY OF THE INVENTION

In accordance with the present invention, an improved miter saw is employed. The miter saw includes a base having a first substantially horizontal surface for supporting a workpiece and a second substantially horizontal surface disposed below the first surface, a table rotatably attached to the base, the table being substantially coplanar with the first surface, a saw assembly movable between a front position and a rear position, the saw assembly comprising a trunnion, a pivot arm pivotally attached to the trunnion, an upper blade guard connected to the pivot arm, a motor attached to the upper blade guard, and a blade driven by the motor, and a fence assembly attached to the base, the fence assembly comprising a fixed fence disposed on the second surface and fixedly attached to the base.

Additional features and benefits of the present invention are described, and will be apparent from, the accompanying drawings and the detailed description below.

### BRIEF DESCRIPTION OF THE DRAWINGS

The accompanying drawings illustrate preferred embodiments of the invention according to the practical application of the principles thereof, and in which:

FIG. 1 is a side view of a first slide miter saw;

FIG. 2 is a side view of a second slide miter saw;

FIG. 3 is a side view of a first embodiment of the fence arrangement according to the invention; and

FIG. 4 is a partial side view of a second embodiment of the fence arrangement according to the invention.

### DETAILED DESCRIPTION

The invention is now described with reference to the accompanying figures, wherein like numerals designate like parts. The present invention can be incorporated into miter saws, chop saws, compound miter saws, slide miter saws, etc. For the sake of convenience, the present invention will be described as applied to a slide miter saw. Nonetheless, persons skilled in the art shall recognize the applicability of the present invention to other power tools.

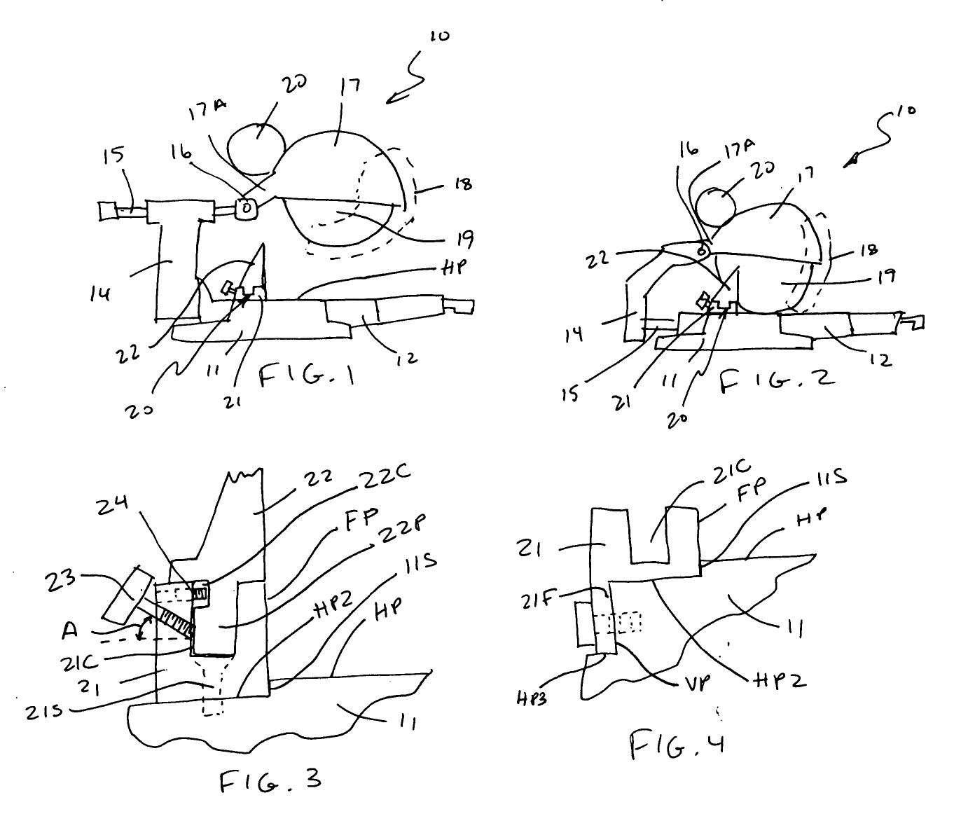

Referring to FIGS. 1-2, slide miter saws 10 have a base 11, a rotatable table 12 attached to the base 11, and a saw assembly which comprises a trunnion 16, a pivot arm 17A pivotably attached to trunnion 16, a motor 20, a blade 19 driven by the motor 20, an upper blade guard 17 for covering an upper part of blade 19, and a lower blade 18 pivotally attached to the upper blade guard 17 for covering a lower part of blade 19. Motor 20 is typically attached to the upper blade guard 17.

The slide miter saws 10 may also have a movable fence assembly 20 attached to the base 11. Movable fence assembly 20 preferably extends laterally across table 12, against which a workpiece can be positioned and supported for performing a cutting operation thereon. Movable fence assembly 20 preferably includes a fixed fence 21 attached to base 11, and a movable fence 22 connected to the fixed fence 21. Movable fence 22 may be slidably attached to fixed fence 21. Persons skilled in the art are referred to U.S. Pat. Nos. 5,297,463 and 5,943,931 for further information on such movable fence assemblies, which are wholly incorporated by reference herein.

Slide miter saws 10 may also have a mechanism to enable the user to move the saw assembly horizontally along the table 12. Referring to FIG. 1, slide miter saw 10 accomplish this by connecting the saw assembly to at least one rail 15, which is slidably attached to a support housing 14 connected to the table 11 (see, e.g., U.S. Pat. No. 6,067,885, incorporated herein by reference).

Alternatively, at least one rail 15 may be slidably connected to table 12, as shown in FIG. 2. Support housing 14 is then fixedly attached to the rail(s) 15. In addition, support housing 14 is attached to trunnion 16. See, e.g., U.S. Pat. No. 5,054,352, which is incorporated herein by reference.

Another arrangement is disclosed in U.S. Pat. No. 5,862,732, which is wholly incorporated herein by reference, where rail 15 is fixedly attached to table 12, and support housing 14 (and the saw assembly) slide along rail 15.

With such arrangements, the user would pull the saw assembly forwardly, move the saw assembly downwardly, then push the saw assembly rearwardly for cutting the workpiece.

Referring to FIGS. 1-3, movable fence 22 and/or fixed fence 21 define a fence plane FP for supporting a workpiece. Preferably, fixed fence 21 and movable fence 22 are substantially coplanar. Fence plane FP is preferably substantially vertical.

In addition, base 11 and/or table 12 define a horizontal plane HP for supporting the workpiece. Preferably, base 11 and table 12 are substantially coplanar.

Referring to FIG. 3, base 11 preferably defines a second horizontal plane HP2, disposed below horizontal plane HP. A shoulder 11S may be disposed between horizontal planes HP, HP2. Fixed fence 21 is preferably disposed on the second horizontal plane HP2 and/or against shoulder 11S. At least one screw 21S may be used to affix fixed fence 21 to base 11. Screw(s) 21S are preferably countersunk into fixed fence 21.

Persons skilled in the art will recognize that screw(s) 21S in FIG. 3 have a substantially vertical axis. FIG. 4 illustrates a second embodiment of movable fence assembly 20, where like numerals refer to like parts. The only major difference between the first and second embodiments is that fixed fence 21 may have a downwardly-extending flange 21F. Preferably flange 21F extends substantially vertically and contacts base 11 along a substantially vertical plane VP and/or a horizontal plane HP3. At least one screw 21S may extend through flange 21F and threadingly engage base 11.

Referring to FIG. 3, movable fence 22 may be slidably disposed on fixed fence 21. Preferably, movable fence 22 has a downwardly-extending protrusion 22P extending into a channel 21C formed by fixed fence 21.

The user can move movable fence 22 along fixed fence 21. In order to lock the position of movable fence 22 relative to fixed fence 21, the user would rotate a lock screw 23, which pushes protrusion 22P into locking contact with fixed fence 21.

The longitudinal axis of screw 23 may be inclined relative to horizontal plane HP and/or fence plane FP. The angle A between the longitudinal axis of screw 23 and horizontal plane HP may be between about 5 degrees and about 25 degrees. Preferably, angle A is about 10 degrees.

Preferably a channel 22C is created in protrusion 22P. A set screw 24 may be disposed in fixed fence 21 and extend into channel 22C. Persons skilled in the art will recognize that set screw 24 may be replaced by a protrusion in fixed fence 21. With such arrangement, movable fence 22 may not be removed from fixed fence 21 by lifting movable fence 22 vertically.

Persons skilled in the art may recognize other additions or alternatives to the means disclosed herein. However, all these additions and/or alterations are considered to be equivalents of the present invention.

What is claimed is:

1. A miter saw comprising:
a base having a first substantially horizontal surface for supporting a workpiece and a second substantially horizontal surface disposed below the first surface;
a table rotatably attached to the base, the table being substantially coplanar with the first surface;
a saw assembly pivotably attached to the table, the saw assembly comprising a motor, and a blade driven by the motor; and
a fence assembly attached to the base, the fence assembly comprising a fixed fence disposed on the second surface and fixedly attached to the base.

2. The miter saw of claim 1, wherein the saw assembly further comprises a trunnion, a pivot arm pivotally attached to the trunnion, and an upper blade guard connected to the pivot arm.

3. The miter saw of claim 2, wherein the motor is attached to the upper blade guard.

4. The miter saw of claim 2, wherein the trunnion is attached to at least one rail slidingly connected to the table.

5. The miter saw of claim 1, wherein the saw assembly further comprises a trunnion pivotally attached to the table, at least one rail slidingly connected to the trunnion, a pivot arm pivotally attached to the at least one rail, and an upper blade guard connected to the pivot arm.

6. The miter saw of claim 5, wherein the motor is attached to the upper blade guard.

7. The miter saw of claim 1, further comprising a movable fence disposed on fixed fence that is movable relative to the fixed fence.

8. The miter saw of claim 7, wherein the movable fence slides relative to the fixed fence.

9. The miter saw of claim 7, wherein the movable fence has a first substantially vertical workpiece-supporting plane.

10. The miter saw of claim 9, wherein the fixed fence has a second substantially vertical workpiece-supporting plane that is substantially coplanar with the first workpiece-supporting plane.

11. The miter saw of claim 7, wherein the movable fence is lockable in position relative to the fixed fence by a screw.

12. The miter saw of claim 11, wherein the screw is inclined relative to at least one of the first workpiece-supporting plane and the first substantially horizontal surface.

13. The miter saw of claim 12, wherein the screw is inclined relative to the first substantially horizontal surface at an angle between about 5 degrees and about 25 degrees.

14. The miter saw of claim 7, wherein the movable fence has a downwardly-extending protrusion received within a channel of the fixed fence.

15. The miter saw of claim 14, wherein a fixed fence protrusion extends from the fixed fence and into the channel, so that the fixed fence protrusion is disposed above the protrusion of the movable fence.

16. The miter saw of claim 15, wherein the fixed fence protrusion is a set screw.

17. The miter saw claim 1, wherein the fixed fence has a downwardly-extending protrusion that contacts a substantially vertical surface of the base.

18. The miter saw of claim 17, wherein a screw extends through the downwardly-extending protrusion of the fixed fence and threadingly engages the base.
